(19) United States
(12) Patent Application Publication
(10) Pub. No.: US 2017/0053234 A1
(43) Pub. Date: Feb. 23, 2017

(54) METHOD AND SYSTEMS FOR TRACKING ASSETS OF SHIPPING TRANSACTIONS IN REAL TIME

(71) Applicants: John Lozito, Encinitas, CA (US); Joonyoul Choi, San Diego, CA (US)

(72) Inventors: John Lozito, Encinitas, CA (US); Joonyoul Choi, San Diego, CA (US)

(73) Assignee: Trakkx COM LLC, Encinitas, CA (US)

(21) Appl. No.: 15/243,670

(22) Filed: Aug. 22, 2016

Related U.S. Application Data
(60) Provisional application No. 62/209,594, filed on Aug. 25, 2015.
(60) Provisional application No. 62/208,503, filed on Aug. 21, 2015.
(60) Provisional application No. 62/277,701, filed on Jan. 12, 2016.
(60) Provisional application No. 62/277,709, filed on Jan. 12, 2016.

(51) Int. Cl. G06Q 10/08

(52) U.S. Cl. CPC G06Q 10/0833

(57) ABSTRACT

Example methods, apparatuses, and systems (e.g., machines) are presented that track in real time shipping transactions in the logistics industry during freight transit. Graphical interfaces are also provided to show with varying degrees of detail and perspective of the progress of the shipments as they travel from one location to the next. Multiple types of users, including the shipper (e.g., a winery), receiver (e.g., a grocery store), broker (e.g., third party middle man helping to coordinate contacts with the parties) and carrier (e.g., truck or trucking company), are provided access to track the same shipment from a common graphical interface according to aspects of the present disclosure.

### CROSS REFERENCE TO RELATED APPLICATIONS

This application claims the benefits of U.S. Provisional Application 62/209,594, filed Aug. 25, 2015, and titled, “METHODS AND SYSTEMS FOR MANAGING SHIPPING TRANSACTIONS,” U.S. Provisional Application 62/208,503, filed Aug. 21, 2015, and titled, “METHODS AND SYSTEMS FOR SHARING PARTNERSHIP DATA IN SHIPPING TRANSACTIONS,” U.S. Provisional Application 62/277,701, filed Jan. 12, 2016, and titled, “METHODS AND SYSTEMS FOR FACILITATING SHIPPING TRANSACTIONS IN VIRTUAL DASHBOARD,” and U.S. Provisional Application 62/277,709, filed Jan. 12, 2016, and titled, “METHODS AND SYSTEMS FOR TRACKING ASSETS OF SHIPPING TRANSACTIONS IN REAL TIME,” the disclosures of which are incorporated herein by reference in their entireties and for all purposes.

This application is also related to US non provisional applications (Attorney Docket No. 1402872.00006_TRX006), titled “METHODS AND SYSTEMS FOR MANAGING SHIPPING TRANSACTIONS,” (Attorney Docket No. 1402872.00007_TRX007), titled “METHODS AND SYSTEMS FOR SHARING PARTNERSHIP DATA IN SHIPPING TRANSACTIONS,” and (Attorney Docket No. 1402872.00008_TRX008), titled “METHODS AND SYSTEMS FOR FACILITATING SHIPPING TRANSACTIONS IN VIRTUAL DASHBOARD,” each of which are filed concurrently herewith, and the entire contents and substance of all of which are hereby incorporated in total by reference in their entireties and for all purposes.

### TECHNICAL FIELD

The subject matter disclosed herein generally relates to processing data. In some example embodiments, the present disclosures relate to systems and methods for tracking assets of shipping transactions in real time.

### BACKGROUND

In shipping transactions, particularly in a shipping supply chain of the trucking industry, generally, multiple distinct parties may be involved to complete a shipping transaction. The multiple parties are generally categorized as one of a shipper, receiver, broker and carrier. Conventionally, there are many companies that can be categorized into each of these different types of parties, unlike the parcel shipping business where there are only a few major companies (e.g., FedEx, UPS, US Postal Service, etc.). Coordinating the many different types of parties, and the many entities categorized within each party, has typically been conducted manually and without complete information. In addition, very little visibility is available during the transport of products in the shipping transaction. It is difficult to know how secure the products are while in transit, for example, and what may be the conditions inside the trailer. It is desirable therefore to provide real-time tracking of the shipping transactions. In general, the trucking industry has a long-standing need for improved organization, logistics, and transparency.

### BRIEF SUMMARY

Aspects of the present disclosure are for systems and methods that that track, in real time, shipping transactions in the logistics industry during freight transit. Graphical interfaces are also provided to show with varying degrees of detail and perspective the progress of the shipments as they travel from one location to the next. In some embodiments, a freight management system for improving transparency in shipping transactions is presented. The system may include: at least one memory; at least one receiver coupled to the at least one memory and configured to receive real-time sensor data from a plurality of shipping assets transporting products in a plurality of shipping transactions; at least one processor coupled to the memory and configured to, in real time: access the real-time sensor data; cause display, in a graphical display of a shipper user, of status information about a shipping transaction among the plurality of shipping transactions, utilizing the real-time sensor data, wherein the shipper user has authorized a product being transported in the shipping transaction; cause display, in a graphical display of a receiver user, of the status information about the shipping transaction, utilizing the real-time sensor data, wherein the receiver user is designated to receive the product being transported in the shipping transaction; and cause display, in a graphical display of a carrier user associated with the shipping transaction, of the status information about the shipping transaction, utilizing the real-time sensor data, wherein the carrier user is in control of a shipping asset that is transporting the product in the shipping transaction.

In some embodiments of the system, the status information comprises a plurality of load status identifiers signaling a current load status of the shipping transaction, the load status identifiers comprising: an “available” status, a “booked” status, a “dispatched” status, a “loading” status, a “loaded” status, an “unloading” status, an “empty” status, a “settled” status, a “partial” status, a “void” status, and an “outside” status.

In some embodiments of the system, the status information comprises information about the carrier performing the shipping transaction, including: a carrier company name, a driver name, a driver contact information, an identifier of the shipping asset, at least one pick-up location, and at least one delivery location.

In some embodiments of the system, causing display of the status information comprises displaying a shipping asset icon overlaid onto a geographic map at a present location of the shipping asset, according to location data derived from the real-time sensor data.

In some embodiments of the system, the processor is further configured to: access a cursor input placed over the shipping asset icon; and in response, cause display of a floating window comprising additional real-time status information about the shipping transaction.

In some embodiments of the system, the status information comprises information about the shipping asset transporting the product in the shipping transaction, including: current speed of the shipping asset, an indication of whether a shipping asset cargo door is closed, a trailer temperature setting indicating an intended temperature inside the trailer, and a current trailer temperature indicating an actual temperature inside the trailer.

In some embodiments of the system, causing display of the status information comprises displaying a plurality of location icons associated with the shipping asset, the plurality of location icons positioned at different locations along a traveled route of the shipping asset during the shipping transaction, the plurality of location icons spaced at said different locations based on a regular time interval.

In some embodiments of the system, the processor is further configured to: access a cursor input placed over any of the location icons; and in response, cause display of a floating window comprising status information about the shipping transaction during a time that the shipping asset traveled at said location icon.

In some embodiments of the system, causing display of the status information comprises displaying a time series of status information over a period of time in a graphical plot.

In some embodiments of the system, the time series of status information comprises a time series of shipping asset speed as a function of time.

In some embodiments of the system, the time series of status information comprises a time series of shipping asset trailer temperature as a function of time.

In some embodiments of the system, the time series of status information comprises a binary time series of when a trailer door is opened and closed as a function of time.

In some embodiments, another freight management system for improving transparency in shipping transactions is presented. This system may include: at least one memory; at least one receiver coupled to the at least one memory and configured to receive real-time sensor data from a plurality of shipping assets transporting products in a plurality of shipping transactions; at least one processor coupled to the memory and configured to, in real time: access the real-time sensor data; cause display, in a graphical display of a user, of status information about each shipping transaction among the plurality of shipping transactions, utilizing the real-time sensor data.

In some embodiments, a computer-readable medium is presented having no transitory signals and embodying instructions that, when executed by a processor, perform operations comprising: accessing real-time sensor data from a plurality of shipping assets transporting products in a plurality of shipping transaction; causing display, in a graphical display of a shipper user, of status information about a shipping transaction among the plurality of shipping transactions, utilizing the real-time sensor data, wherein the shipper user has authorized a product being transported in the shipping transaction; causing display, in a graphical display of a receiver user, of the status information about the shipping transaction, utilizing the real-time sensor data, wherein the receiver user is designated to receive the product being transported in the shipping transaction; and causing display, in a graphical display of a carrier user associated with the shipping transaction, of the status information about the shipping transaction, utilizing the real-time sensor data, wherein the carrier user is in control of a shipping asset that is transporting the product in the shipping transaction.

### BRIEF DESCRIPTION OF THE DRAWINGS

Some embodiments are illustrated by way of example and not limitation in the figures of the accompanying drawings.

FIG. 1 is a network diagram illustrating an example network environment suitable for aspects of the present disclosure, according to some example embodiments.

FIG. 2 shows an example entry interface for accessing the real time tracking capabilities of the present disclosures, in some embodiments.

FIG. 3 shows an example view of the Track Order page, according to some embodiments.

FIG. 4 shows an example display of the Map Section, according to some embodiments.

FIG. 5 shows an example display of the Charts Section, according to some embodiments.

FIG. 6 shows an example display of the Check Calls Section, according to some embodiments.

FIG. 7 shows an example display of the Order Map View, according to some embodiments.

FIG. 8 shows a filter dialog display in the Order Map View, according to some embodiments.

FIG. 9 shows a display option for further filtering individually from the resulted orders in the Orders section.

FIG. 10 shows an Asset Map View to show a company's asset centric map presentation.

FIG. 11 shows a filter dialog display that can be used to select assets belonging to the company by applying filter criteria.

FIG. 12 shows an Assets page that provides a table summary of multiple assets at once.

FIG. 13 shows available asset filtering options along with an example Asset Map display with a selected time range applied.

FIG. 14 shows an example of the summary statistics and the asset time range that may give rise to the graphics provided in FIG. 13.

FIG. 15 is a block diagram illustrating components of a machine, according to some example embodiments, able to read instructions from a machine-readable medium and perform any one or more of the methodologies discussed herein.

### DETAILED DESCRIPTION

Example methods, apparatuses, and systems (e.g., machines) are presented that track, in real time, shipping transactions in the logistics industry during freight transit. Graphical interfaces are also provided to show with varying degrees of detail and perspective the progress of the shipments as they travel from one location to the next. Multiple types of users, including the shipper (e.g., a winery), receiver (e.g., a grocery store), broker (e.g., third party middle man helping to coordinate contacts with the parties) and carrier (e.g., truck or trucking company), are provided access to track the same shipment from a common graphical interface according to aspects of the present disclosure. In addition, each type of user in the logistics chain is provided information to ensure product integrity all occurring in real time. Example details include constant updates of the truck's (asset's) speed, the trailer temperature, location monitoring illustrated at regular intervals, whether the trailer door has been opened along the route and at what time, dispatch calls made to the asset, and whether the shipment changes hands along the route. Unlike the parcel shipping business where there are only a few major companies (e.g., FedEx, UPS, US Postal Service, etc.), tracking shipments in the freight industry include multiple players, including at times multiple carriers to deliver a shipment along the same route. Subleasing contracts from a primary carrier to a secondary carrier is a common practice, and it is difficult for a shipper and receiver to know the status of its shipment through conventional means. Aspects of the present disclosure provide dramatically improved visibility into the shipping process of the freight industry in order to offer greater security to shipments. Through the real time tracking system of the present disclosures, each type of company in the shipping chain has access to the same tracking information, occurring in real time, to create more reliability and accountability for and between all involved parties.

In some embodiments, if freight company carriers are carrying out freight orders with freight tracker equipped assets according to the present disclosures, any freight company users involved with the target order can track the asset real time through the freight management website as other freight system components are monitoring all the asset movements. In general, freight trackers may be equipped with GPS and accelerometers and are capable of adding other sensors, like temperature sensors and sensors to detect a door opens or closes, and they may report monitored readings with a very short interval for the most current data. A separate status tracking service is running all the time to assess an assets' geofencing activities to move forward an order status and to check alarm trigger conditions to send out notifications to pre-configured audiences.

Examples merely demonstrate possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

The following definitions may be used herein.

Freight management system: Main freight management website, including an administrative freight management website, installation phone utility application, freight management software services, freight management tracker hardware and software subsystems.

The freight management system of the present disclosures brings a revolutionary logistics business facilitation and modernization platform that utilizes social network software aspects for intricacy of trucking load processing and cellular communication network with GPS and monitoring sensors for product integrity information.

Freight management company: a company which signed up for the freight management website. The freight management company may have one or more roles typical in the trucking industry, described more below.

Freight management user: a user under a signed-up freight management company. The freight management company can have multiple users.

Freight management company roles follow the business entities in the trucking supply chain/logistics, which are Shipper, Receiver, Broker and Carrier. A shipper generally is defined as an entity that has goods to be moved to a receiver, such as a manufacturer of goods. A receiver generally is defined as an entity that is designated to receive goods from a shipper, such as a retail store or grocery store. A carrier generally is defined as an entity designated to pick up a shipment of goods and transport said goods to a designated location. The carrier generally is in control of shipping assets, like one or more trucks (e.g., 18 wheelers). A carrier may be a single individual who owns a truck and uses his truck to pick up and transport goods, or may be a larger organization that controls a fleet of trucks and drivers. While some companies have integrated solutions and include carrier functionality for its shipping or receiving operations, it is often the case that the shipper, carrier, and receiver are distinct and separate entities. A broker generally is defined as a coordinator to facilitate the completion of the shipping supply chain between the shipper, carrier, and receiver. A broker may be responsible for contacting various carriers to fulfill shipping and receiving needs, for example.

Freight management company can identify itself and utilize the freight management system as one or multiples of business roles where the freight management website provides unprecedented visibility to the freight management companies.

Partnership: freight management companies can establish partnerships amongst themselves to benefit each other in the business practice to facilitate their own operations.

Contact: There are three types of contacts—public (from e.g., FMCSA database), private (e.g., Freight management company maintained from public contacts) and my company public (e.g., company's public list compilation if it has multiple locations).

Asset: A freight management tracker attached trailer or tractor of the truck.

Order: A freight management order is a work order or shipping/delivery load which encompasses all the necessary information to move goods from A to B including pickups, deliveries, carrier, tracking, requirement, sharing, equipment, driver, finance information, product integrity information such as temperature, speed and more.

Order has eight status including AVL (available), BKD (booked), DIS (dispatched), LDG (loading), LDD (loaded), ULD (unloading), MT (empty) and STL (settled). Other statuses readily apparent to those with ordinary skill in the art are also possible, and embodiments are not so limited.

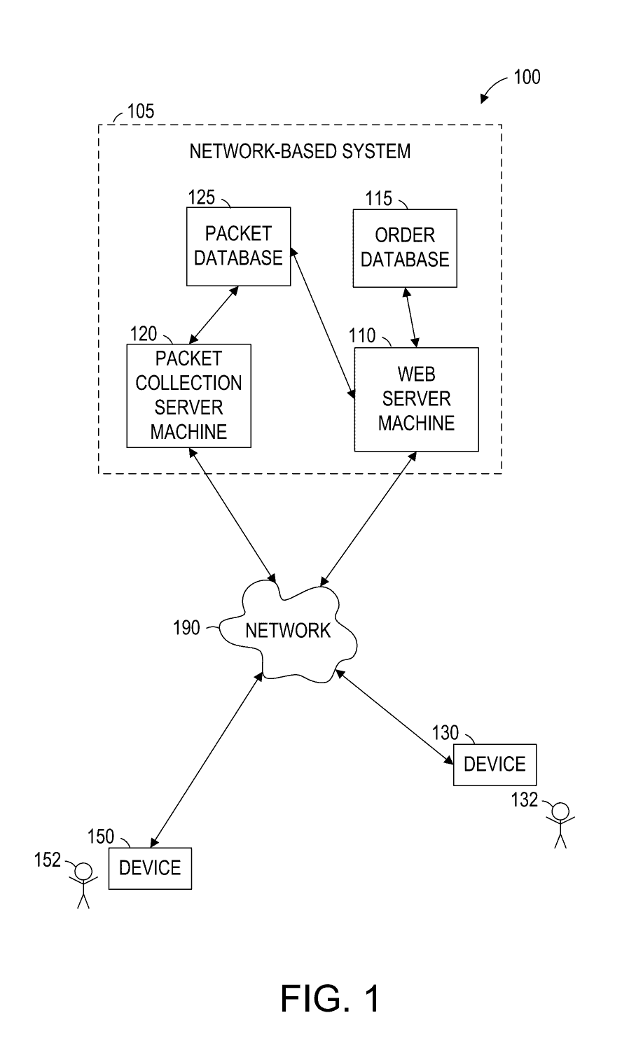

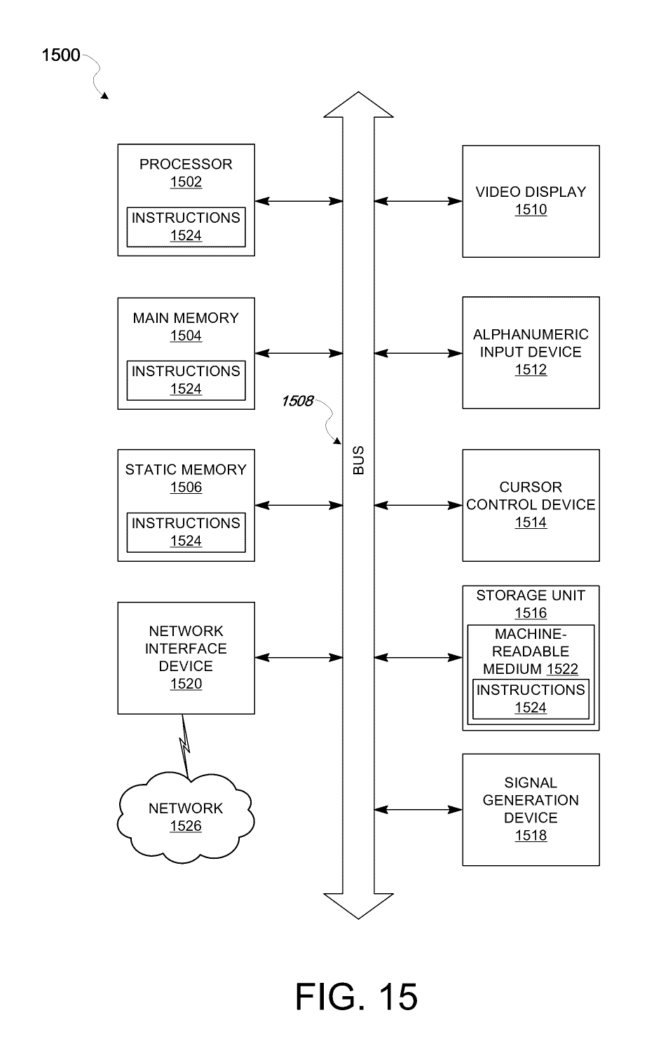

Referring to FIG. 1, a network diagram illustrating an example network environment 100 suitable for performing aspects of the present disclosure is shown, according to some example embodiments. The example network environment 100 includes a web server machine 110, an order database 115, a packet collection server machine 120, a packet database 125, a first device 130 for a first user 132, and a second device 150 for a second user 152, wherein the server machines 110 and 120 are communicatively coupled to the devices 130 and 150 via a network 190. In some embodiments, either or both of the web server machine 110 and packet collection server machine 120 may form all or part of a network-based system 105 (e.g., a cloud-based server system configured to provide one or more services to the first and second devices 130 and 150). The web server machine 110, the packet collection server machine 120, the first device 130, and the second device 150 may each be implemented in a computer system, in whole or in part, as described below with respect to FIG. 15. Through this example configuration of the network-based system 105, aspects of the present disclosure may be configured to enable either of the devices 130 or 150 to track information derived from the other device 150 or 130, as well as track any web interface devices, such as if device 130 or 150 operates as a web interface device. In other words, the devices 130 and 150 may be configured to interface with the system of the present disclosures, as well as with other devices, through both a web-based interface and through an app-based interface.

Also shown in FIG. 1 are the first user 132 and the second user 152. One or both of the first and second users 132 and 152 may be a human user, a machine user (e.g., a computer configured by a software program to interact with the first device 130), or any suitable combination thereof (e.g., a human assisted by a machine or a machine supervised by a human). The first user 132 may be associated with the first device 130 and may be a user of the first device 130. For example, the first device 130 may be a desktop computer, a vehicle computer, a tablet computer, a navigational device, a location tracking device, a monitoring sensor data collecting device, a portable media device, a smartphone, or a wearable device (e.g., a smart watch or smart glasses) belonging to the first user 132. Likewise, the second user 152 may be associated with the second device 150. As an example, the second device 150 may be a desktop computer, a vehicle computer, a tablet computer, a navigational device, a location tracking device, a monitoring sensor data collecting device, a portable media device, a smartphone, or a wearable device (e.g., a smart watch or smart glasses) belonging to the second user 152. Other devices, not shown, may also be configured to interface with the network-based server 105 similar to devices 130 and 150, and embodiments are not so limited. For example, the first device 130 may be operated by a shipper, the second device 150 may be operated by a carrier, a third device may be operated by a broker, and a fourth device may be operated by a receiver, all of which may be configured to transmit and receive information about a shipping transaction from each other device.

Any of the machines 110 and 120, databases 115 and 125, or first or second devices 130 or 150 shown in FIG. 1 may be implemented in a general-purpose computer modified (e.g., configured or programmed) by software (e.g., one or more software modules) to be a special-purpose computer to perform one or more of the functions described herein for that machine 110 or 120, database 115 or 125, or first or second device 130 or 150. For example, a computer system able to implement any one or more of the methodologies described herein is discussed below with respect to FIG. 15. As used herein, a “database” may refer to a data storage resource and may store data structured as a text file, a table, a spreadsheet, a relational database (e.g., an object-relational database), a triple store, a hierarchical data store, any other suitable means for organizing and storing data or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines 110 and 120, databases 115 and 125, and devices 130 and 150. Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include, for example, one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 190 may communicate information via a transmission medium. As used herein, “transmission medium” may refer to any intangible (e.g., transitory) medium that is capable of communicating (e.g., transmitting) instructions for execution by a machine (e.g., by one or more processors of such a machine), and can include digital or analog communication signals or other intangible media to facilitate communication of such software.

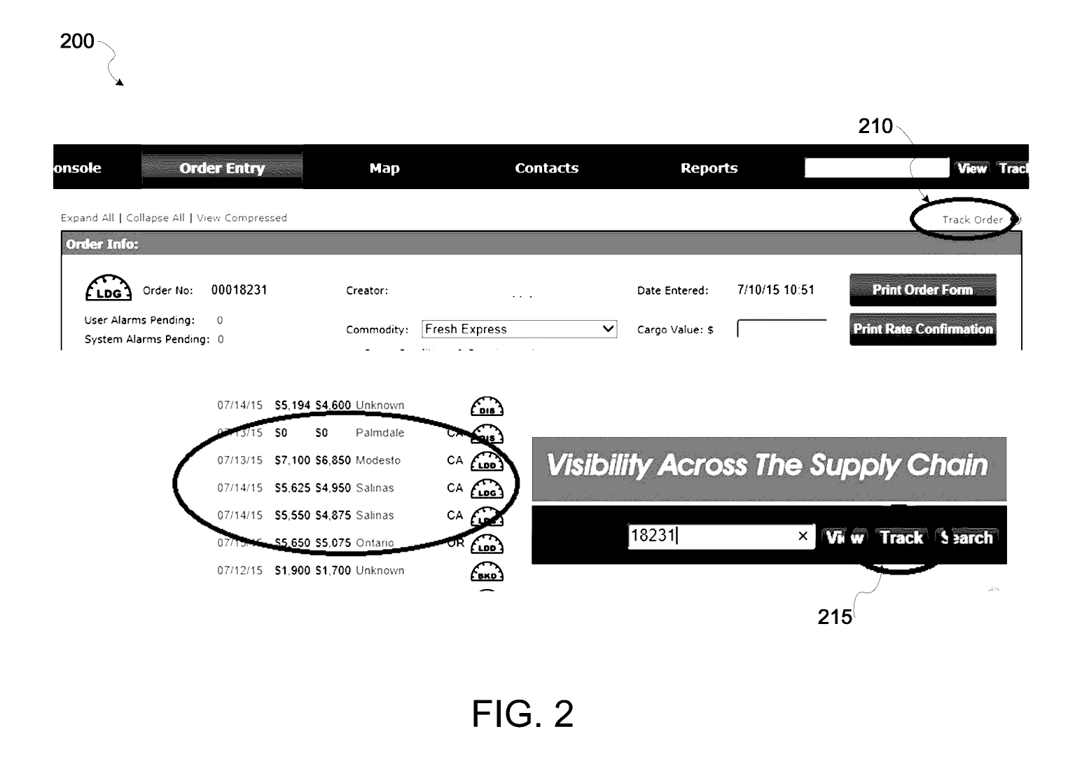

Referring to FIG. 2, illustration 200 shows an example entry interface for accessing the real time tracking capabilities of the present disclosures, in some embodiments. The example interface may be shown in a user terminal device, such as devices 130 or 150, and may be displayed by the network-based system 105 implementing the freight management system of the present disclosures. Here, coupled with details from the Order Entry page (see US non-provisional applications (Attorney Docket Nos. 1402872.00006 and 1402872.00008), both incorporated by reference), a user may select the “Track Order” buttons 210 or 215 to view shipment tracking information. The Track Order page achieves unprecedented visibility by providing a location and product integrity tracking view of a single order. In some embodiments, it may be accessed from the toggle link from the Order Entry tab, location context sensitive link from the personalized dashboard view or direct Track button with target order number.

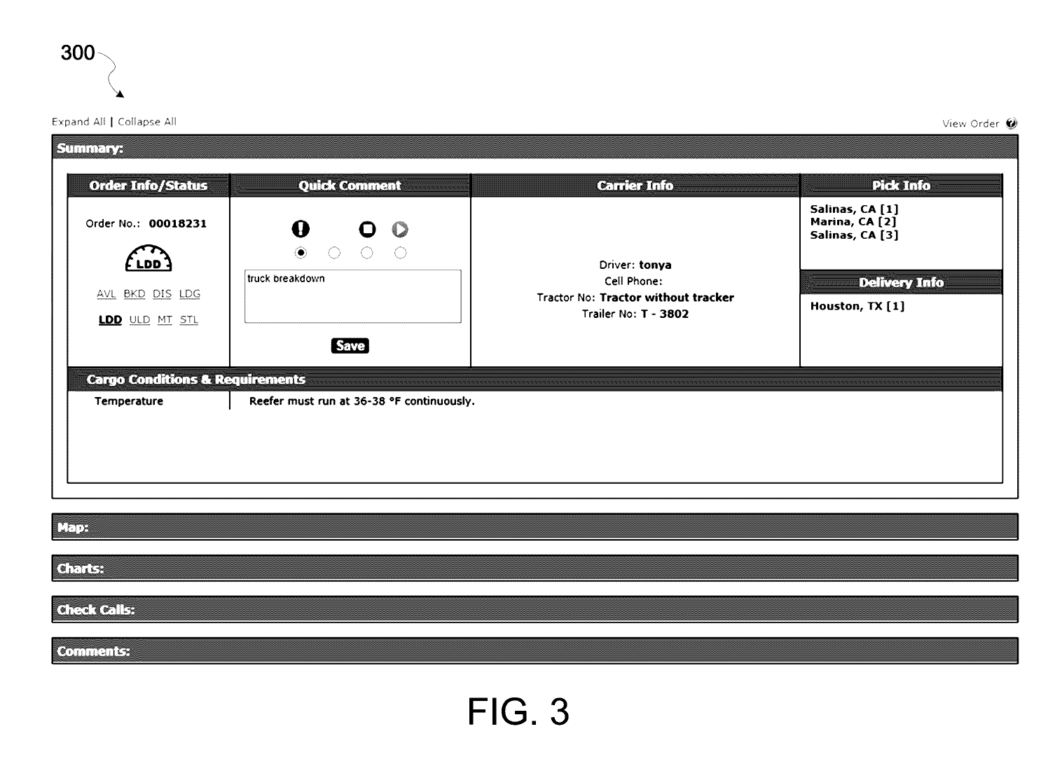

Referring to FIG. 3, an example view of the Track Order page is shown, according to some embodiments. The Track Order page includes different graphical features, such as Summary, Map, Charts, Check Calls and Comments sections.

Here, in the Summary section 300, a brief summary of the order status, carrier info, pickup/delivery info, and requirements is shown along with any quick comments regarding any relevant information for the shipping process. The order status displays show which stage of the example eight statuses (e.g., AVL (available), BKD (booked), DIS (dispatched), LDG (loading), LDD (loaded), ULD (unloading), MT (empty) and STL (settled)) the target order is currently at. In other cases, other statuses may be used, and embodiments are no so limited. In general, as shown, the summary section 300 shows basic but fundamental information about the target order, including information about the particular carrier, pick-up information, delivery information, and cargo conditions and requirements.

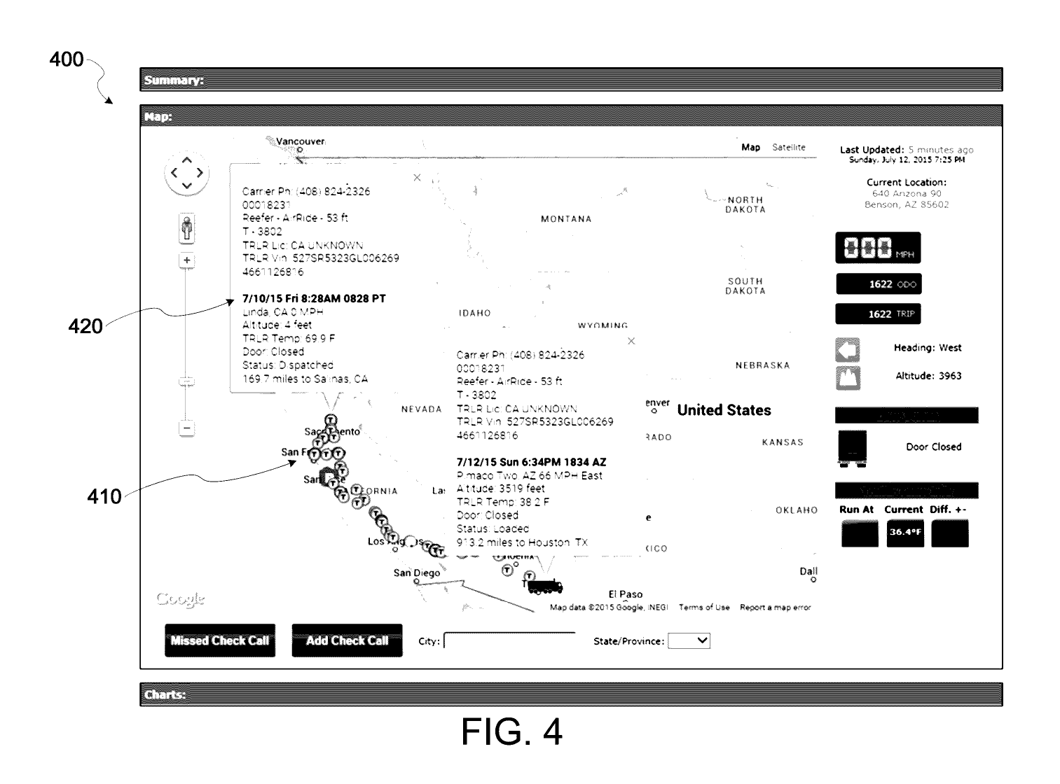

Referring to FIG. 4, illustration 400 shows an example display of the Map Section, according to some embodiments. Here shown are a series of “bread crumbs” 410 that form a trail of the asset's path as the truck moves around pickups and forwards to destination(s). In some embodiments, each trail spot can show an info window 420 about location and load related properties of the recorded time. Also, the right side presents very current information such as the latest location, heading direction, altitude, total traveled distance as well as door open/close status and temperature reading. If an unavoidable manual location recording situation arises, it can be entered through a manual check call section.

The tools used to provide such information may include GPS sensors with altitude detection, temperature sensors inside the storage areas of the truck, sensors connected to odometers, and sensors attached to the doors, as some examples. The sensors may be wired to the battery of the truck for power, or may have separate batteries running at low power (or both). All of these sensors may have time stamping capabilities, or may be connected to a GPS with timestamping capabilities via satellite connection. The information may be transmitted across cell towers or other radio frequency beacons, as well as transmitted via telecommunications satellite in some cases.

As an example, in some embodiments, the network-based system 105 may be configured to access the various sensor, timing, and coordinate data from the various sensors on any number of assets to provide the data to users via one or more displays of the real-time tracking program described herein. The network-based system may receive the data through wired or wireless means, connected via satellite or other wireless receiver. At least one processor of the network-based system 105 may be configured to continuously stream the data. Various buffer processing or other large cached systems and memory may compile the data in a known format, whereby the network-based system 105 may then display icons on a geographic map and other graphical displays according to the location data that is received. In some cases, the network-based system 105 may be configured to poll the various sensors via wireless means, based on last known locations, to reduce refresh rates. In other cases, a combination of polling by the centralized network-based system and periodic transmission by the assets may be provided. In general, once the data is compiled into the system, information may be correlated according to unique identifiers, such as a unique ID of a particular sensor, or a unique ID of an asset. The data may then be organized accordingly and displayed in various graphical icons and windows, as described further herein.

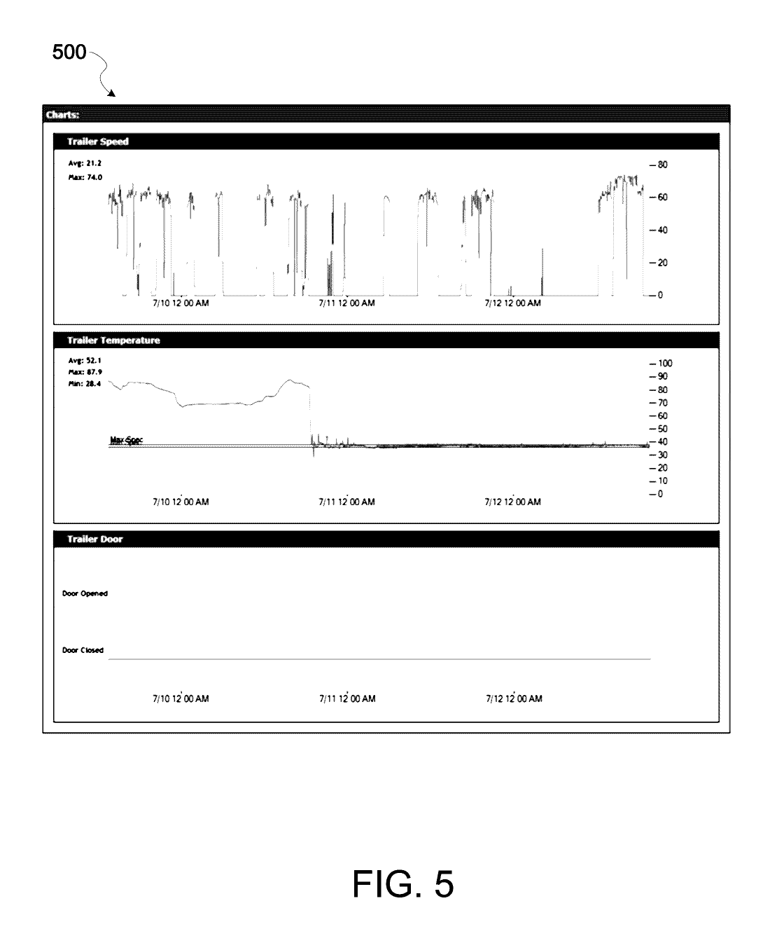

Referring to FIG. 5, illustration 500 shows an example display of the Charts Section, according to some embodiments. Here, three charts of Trailer Speed, Trailer Temperature and Trailer Door Open/Close status display time trending graphs to quickly convey product integrity history. One may be able to monitor if there are any anomalies in the shipment through these different real time graphs.

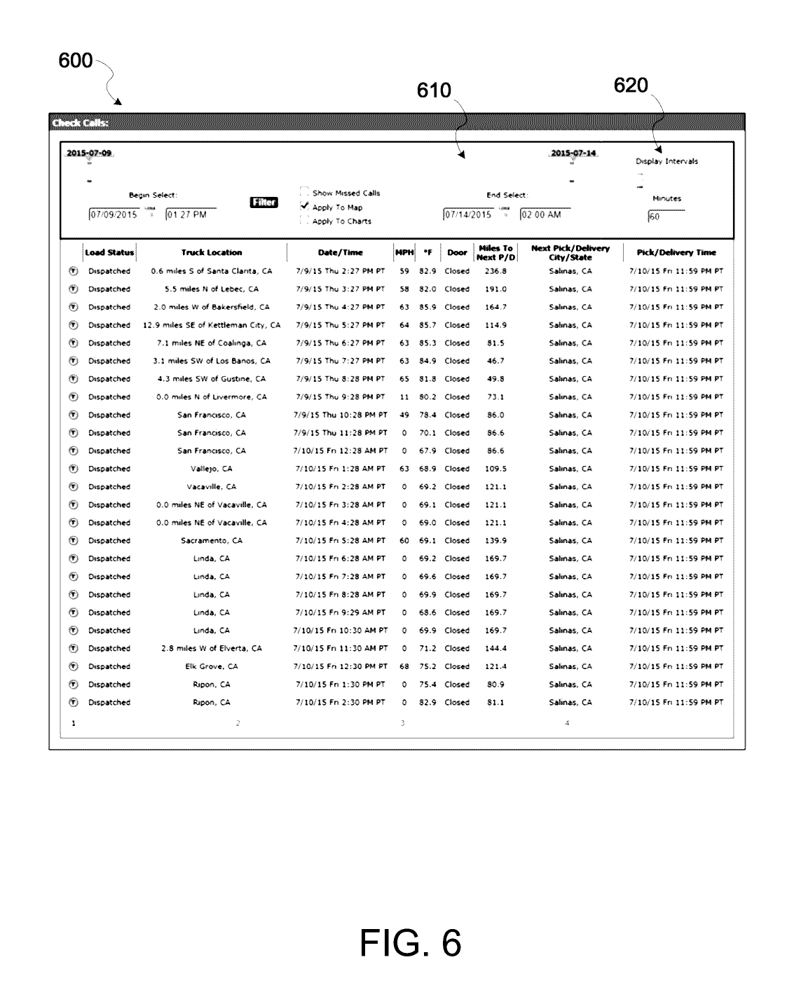

Referring to FIG. 6, illustration 600 shows an example display of the Check Calls Section, according to some embodiments. Here, a tabular form of location and product integrity history data is shown along with data filtering controls. Note that all Map, Chart, and Check Calls data are time synced initially and filtering controls can apply time filtering to individual sections or altogether. A date slider 610 provides easy time range selection, while an interval slider 620 offers data density control, which is particularly useful to clean too-much-data clutter, by spacing out the display time interval.

The Track Order page containing these example displays in FIGS. 4-6 may be automatically refreshed to show any updated information as the truck moves. Each type of entity involved in the transaction, i.e., the shipper, broker, carrier and receiver all can know exactly where and how their order load has traveled and is traveling now.

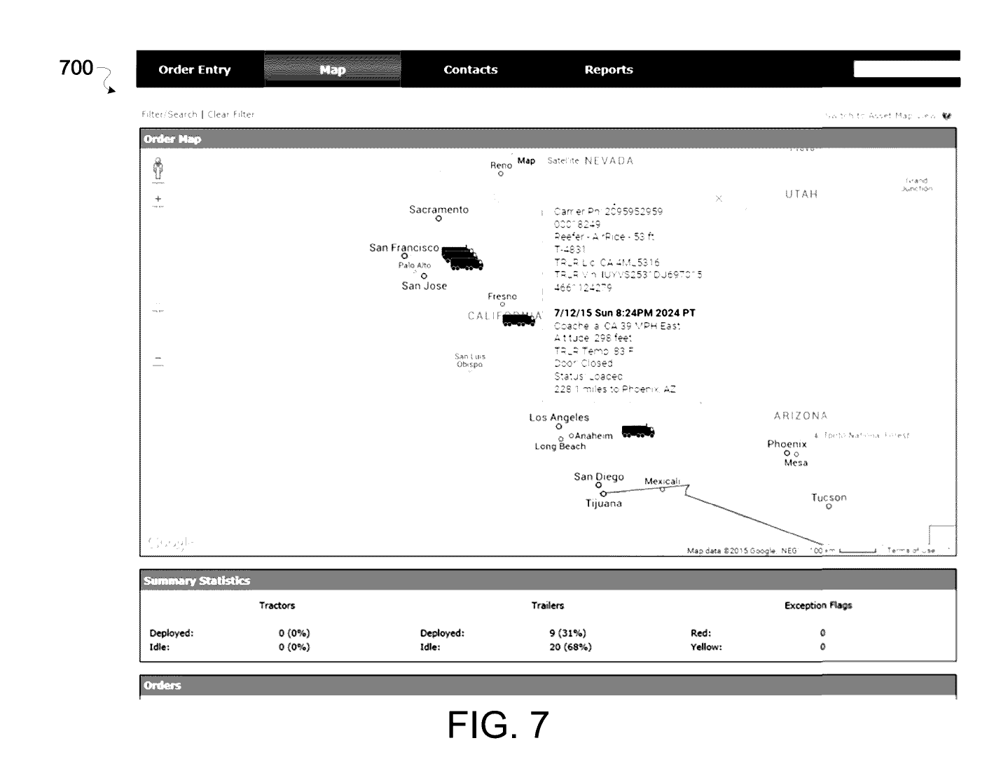

Referring to FIGS. 7, 8, and 9, while the Track Order page may be updating information for tracking a specific order of interest, another display in the Order and Asset Map page views under the Map menu are showing group-wise tracking information. The view to show multiple orders may be shown either order-centric or asset-centric. FIGS. 7, 8, and 9 show an example of the order-centric view.

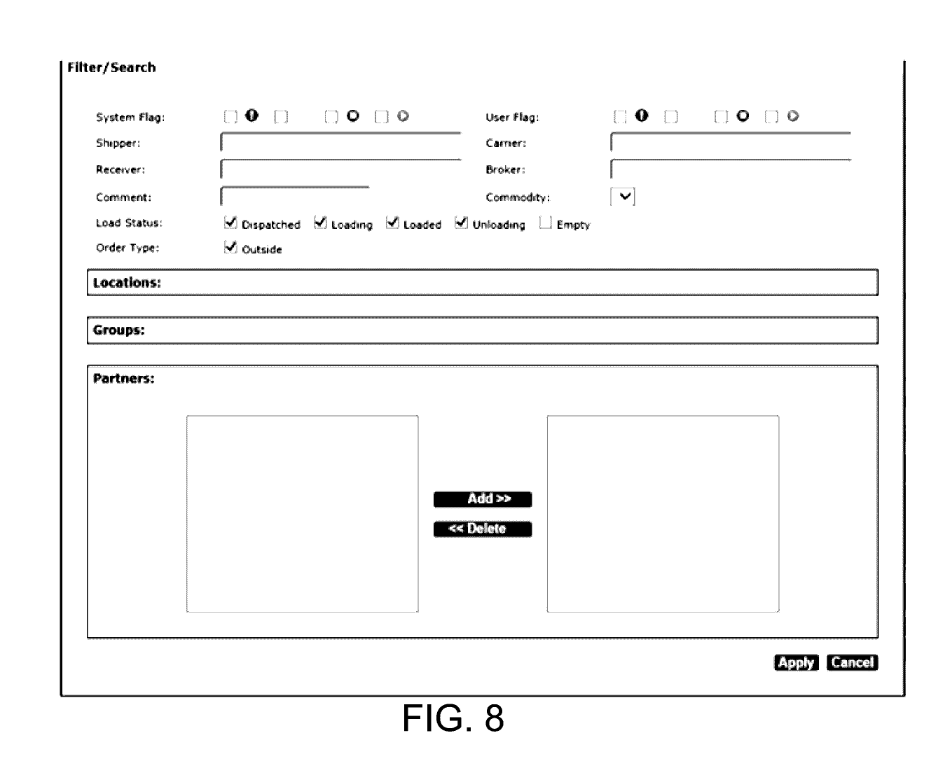

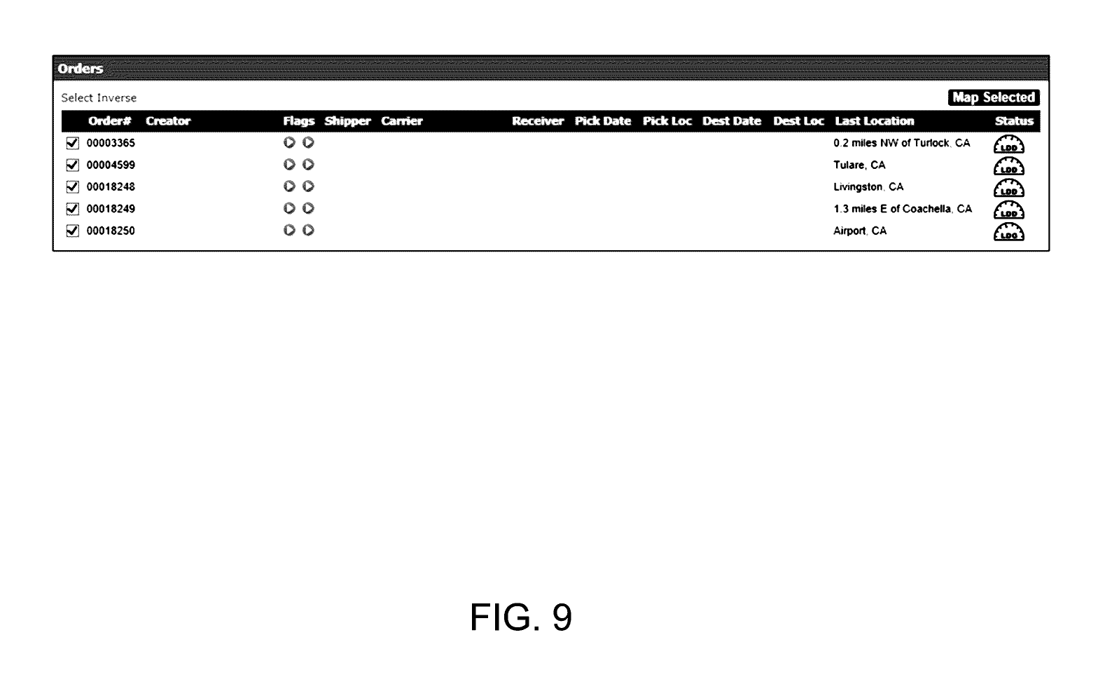

Referring to FIG. 7, illustration 700 shows an example display of the Order Map View, according to some embodiments. Here shown is a map presentation for any selected orders available to users offering how the company's assets are being used for current orders at a glance. From this perspective, a single asset may include multiple orders. In such instances, in some embodiments, a single truck icon may be shown, while in others, multiple truck icons of the same truck asset may be shown, so that a user can toggle through each individual truck icon to view specific details about each order. The user can select orders in a similar fashion as in the personalized dashboard view with the filter dialog (see FIG. 8) and further filtered in or out individually from resulted orders in the Orders section (see FIG. 9). FIG. 9 shows a list view of each (or all) of the orders selected or within the company, featuring particular information to uniquely identify each order and to provide a set of useful information.

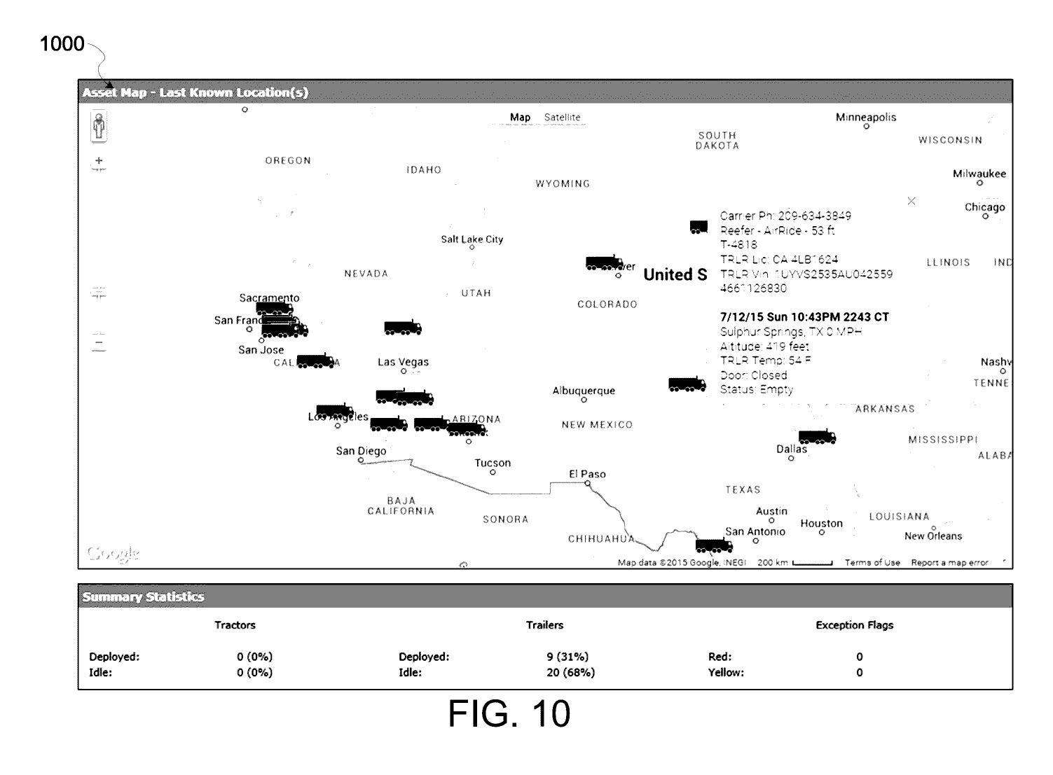

Referring to FIGS. 10, 11, and 12, in some embodiments, additional example views are provided for showing the overall status of multiple assets in this asset-centric view. In illustration 1000 of FIG. 10, an Asset Map View is provided to show a company's asset-centric map presentation. Here, multiple assets are displayed in the same display, as shown by the multiple truck icons at different locations across a map of the United States. Each truck icon represents an individual asset, e.g., a carrier truck, which may be carrying multiple orders. A user may select one of the truck icons, in some cases by clicking and in others by simply scrolling over the icon, to show current status indicators of the shipment of the selected asset, as shown. Aggregate statistics are also provided on the bottom graphics in the Summary Statistics section.

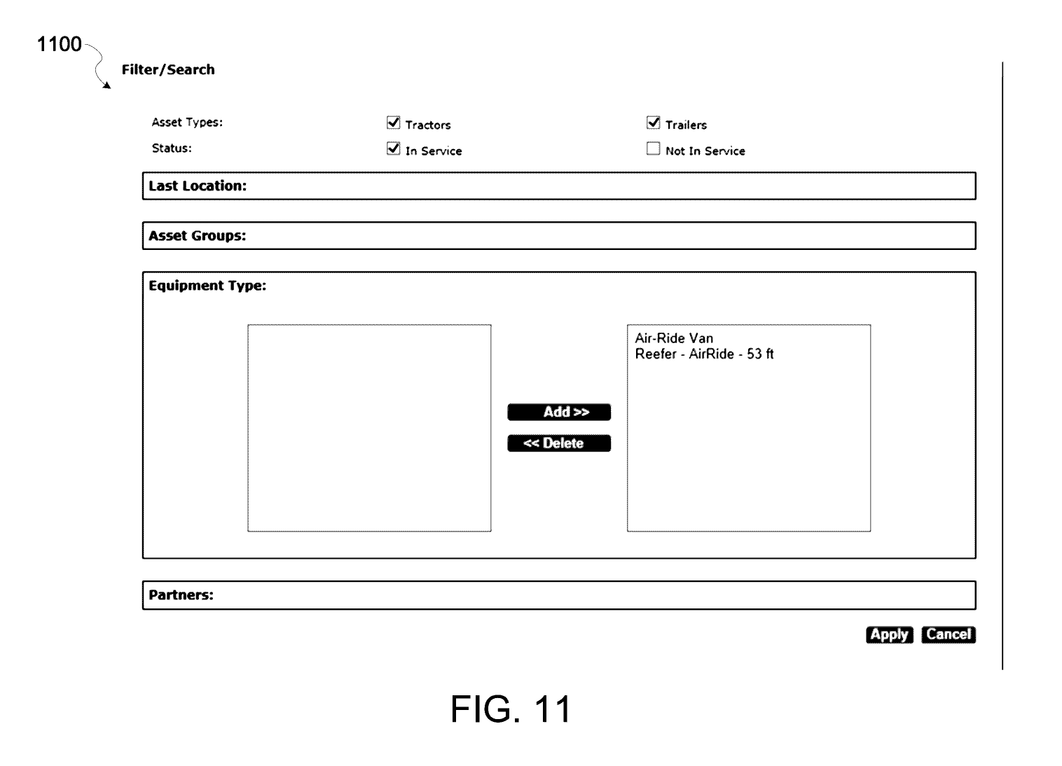

In illustration 1100 of FIG. 11, a filter dialog display can be used to select assets belonging to the company by applying filter criteria. For example, if a vast number of assets are in transit, it may be desirable to limit the number of assets shown at any one time. Various options may be selected to filter the number of assets, such as showing only trailers, those in service, or those with certain types of equipment installed. In addition, assets connected to one or more partners may also be included, according to some embodiments.

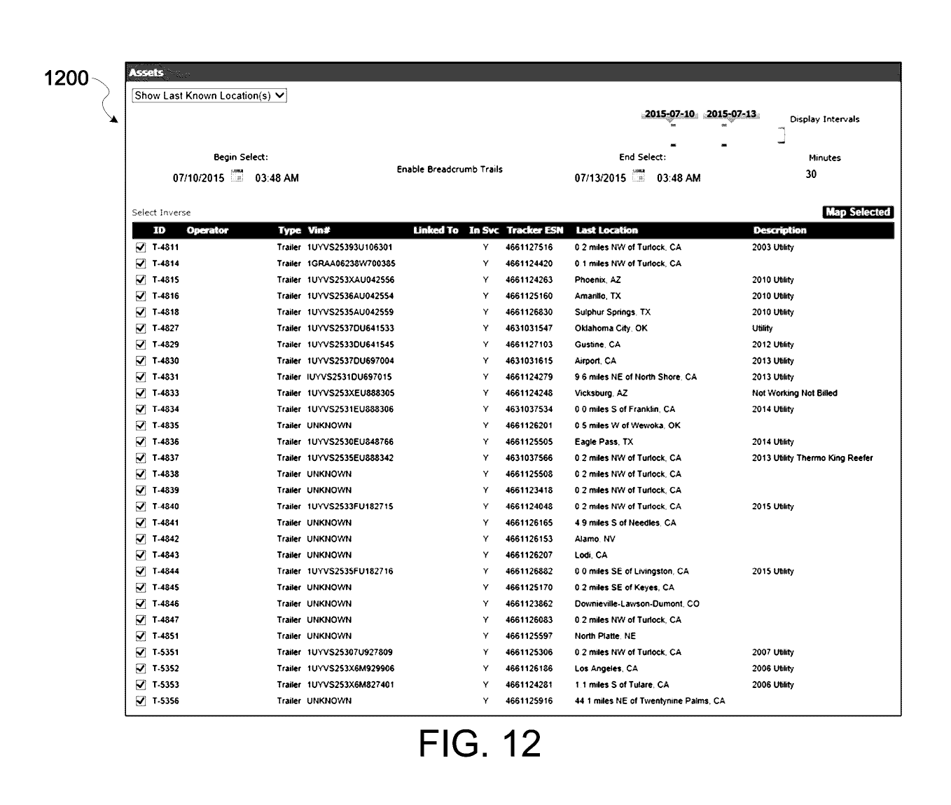

Referring to FIG. 12, illustration 1200 shows an Assets section that provides a table summary of multiple assets at once. Here, the filtered assets from FIG. 11 can be further picked individually to be shown in map section of the Asset Map display of FIG. 10, for example, just like in the Order Map View. These options allow for a user to very flexibly customize the asset tracking, providing great visibility as to the status of the routes where previously little visibility was available Similar to the summary view of the order-centric view, a sliding bar at the top is available to show assets within a date range, and an interval bar is also available to change the density of data points within a given date range.

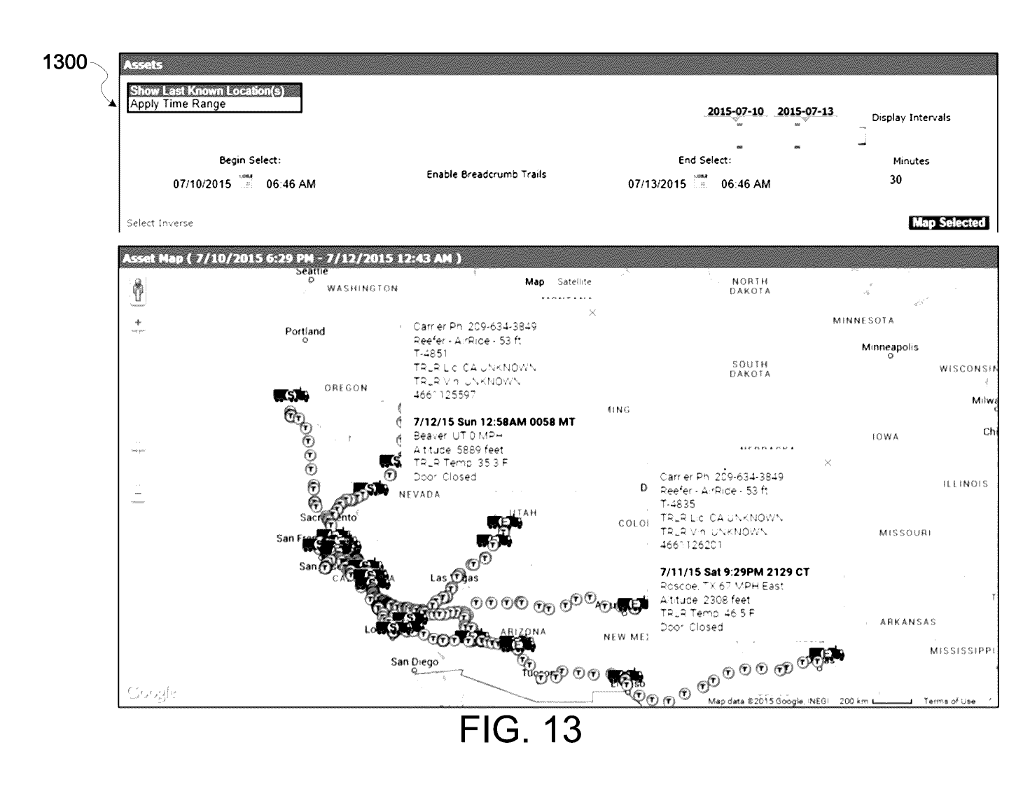

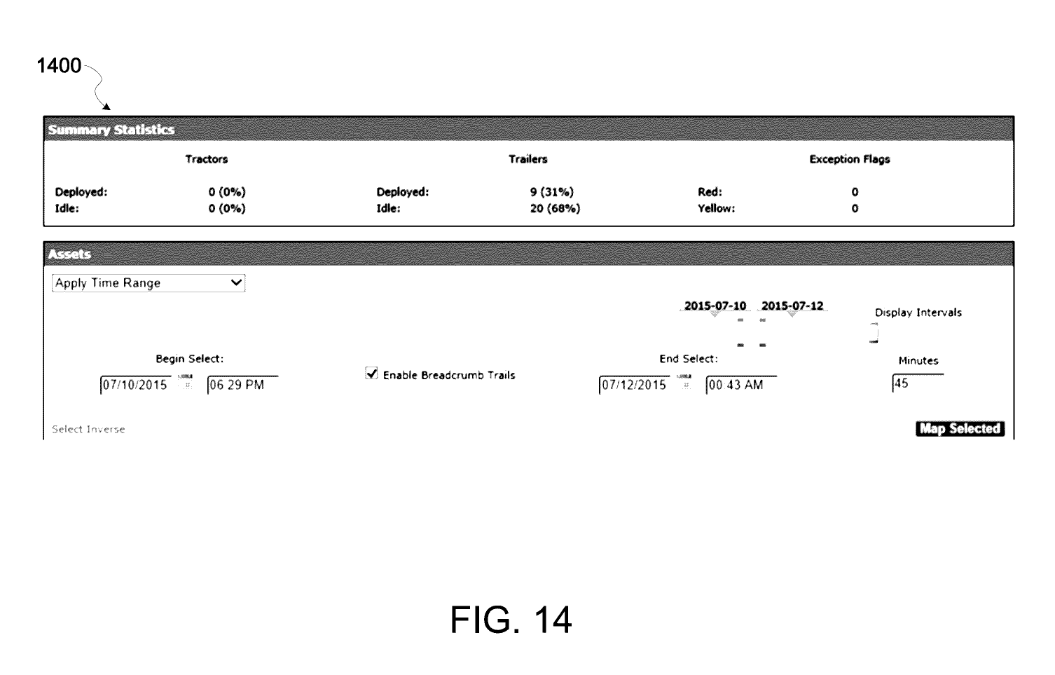

Referring to FIGS. 13 and 14, in some embodiments, a graphical view of several combined features may be shown as well. For example, the Asset Map View's default filtering option is to show the latest known locations of the selected assets. However, the user can change to a Time Range option and investigate the status of assets for a given time period. In illustration 1300 of FIG. 13, available filtering options along with an example Asset Map display are shown with a selected time range applied. The “breadcrumb” option can be also turned on to display trails of assets. In addition, multiple trails from multiple assets may be shown in the same display. These can be combined with the ability to query any single “breadcrumb” by either scrolling over the point or selecting it, thereby displaying the relevant information about the asset at that particular recorded time. Altogether, these views allow for a comprehensive view of the movements of multiple assets during any specified time period.

Referring to FIG. 14, illustration 1400 shows an example of the summary statistics and the asset time range that may give rise to the graphics provided in FIG. 13. The sliding bar can allow for various time ranges to be shown, not just as the most current time. The display intervals sliding bar also allows for different levels of detail based on how dense the data points are spaced, e.g., every 45 minutes.

Referring to FIG. 15, the block diagram illustrates components of a machine 1500, according to some example embodiments, able to read instructions 1524 from a machine-readable medium 1522 (e.g., a non-transitory machine-readable medium, a machine-readable storage medium, a computer-readable storage medium, or any suitable combination thereof) and perform any one or more of the methodologies discussed herein, in whole or in part. Specifically, FIG. 15 shows the machine 1500 in the example form of a computer system (e.g., a computer) within which the instructions 1524 (e.g., software, a program, an application, an applet, an app, or other executable code) for causing the machine 1500 to perform any one or more of the methodologies discussed herein may be executed, in whole or in part.

In alternative embodiments, the machine 1500 operates as a standalone device or may be connected (e.g., networked) to other machines. In a networked deployment, the machine 1500 may operate in the capacity of a server machine 110 or a client machine in a server-client network environment, or as a peer machine in a distributed (e.g., peer-to-peer) network environment. The machine 1500 may include hardware, software, or combinations thereof, and may, as example, be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 1524, sequentially or otherwise, that specify actions to be taken by that machine. Further, while only a single machine 1500 is illustrated, the term “machine” shall also be taken to include any collection of machines that individually or jointly execute the instructions 1524 to perform all or part of any one or more of the methodologies discussed herein.

The machine 1500 includes a processor 1502 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1504, and a static memory 1506, which are configured to communicate with each other via a bus 1508. The processor 1502 may contain microcircuits that are configurable, temporarily or permanently, by some or all of the instructions 1524 such that the processor 1502 is configurable to perform any one or more of the methodologies described herein, in whole or in part. For example, a set of one or more microcircuits of the processor 1502 may be configurable to execute one or more modules (e.g., software modules) described herein.

The machine 1500 may further include a video display 1510 (e.g., a plasma display panel (PDP), a light emitting diode (LED) display, a liquid crystal display (LCD), a projector, a cathode ray tube (CRT), or any other display capable of displaying graphics or video). The machine 1500 may also include an alphanumeric input device 1512 (e.g., a keyboard or keypad), a cursor control device 1514 (e.g., a mouse, a touchpad, a trackball, a joystick, a motion sensor, an eye tracking device, or other pointing instrument), a storage unit 1516, a signal generation device 1518 (e.g., a sound card, an amplifier, a speaker, a headphone jack, or any suitable combination thereof), and a network interface device 1520.

The storage unit 1516 includes the machine-readable medium 1522 (e.g., a tangible and non-transitory machine-readable storage medium) on which are stored the instructions 1524 embodying any one or more of the methodologies or functions described herein, including, for example, any of the descriptions of FIGS. 1-14. The instructions 1524 may also reside, completely or at least partially, within the main memory 1504, within the processor 1502 (e.g., within the processor's cache memory), or both, before or during execution thereof by the machine 1500. The instructions 1524 may also reside in the static memory 1506.

Accordingly, the main memory 1504 and the processor 1502 may be considered machine-readable media 1522 (e.g., tangible and non-transitory machine-readable media). The instructions 1524 may be transmitted or received over a network 1526 via the network interface device 1520. For example, the network interface device 1520 may communicate the instructions 1524 using any one or more transfer protocols (e.g., HTTP). The machine 1500 may also represent example means for performing any of the functions described herein, including the processes described in FIGS. 1-14.

In some example embodiments, the machine 1500 may be a portable computing device, such as a smart phone or tablet computer, and have one or more additional input components (e.g., sensors or gauges) (not shown). Examples of such input components include an image input component (e.g., one or more cameras), an audio input component (e.g., a microphone), a direction input component (e.g., a compass), a location input component (e.g., a GPS receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium 1522 able to store data temporarily or permanently and may be taken to include, but not be limited to, random-access memory (RAM), read-only memory (ROM), buffer memory, flash memory, and cache memory. While the machine-readable medium 1522 is shown in an example embodiment to be a single medium, the term “machine-readable medium” should be taken to include a single medium or multiple media (e.g., a centralized or distributed database 115, or associated caches and servers) able to store instructions 1524. The term “machine-readable medium” shall also be taken to include any medium, or combination of multiple media, that is capable of storing the instructions 1524 for execution by the machine 1500, such that the instructions 1524, when executed by one or more processors of the machine 1500 (e.g., processor 1502), cause the machine 1500 to perform any one or more of the methodologies described herein, in whole or in part. Accordingly, a “machine-readable medium” refers to a single storage apparatus or device 130 or 150, as well as cloud-based storage systems or storage networks that include multiple storage apparatus or devices 130 or 150. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Furthermore, the machine-readable medium 1522 is non-transitory in that it does not embody a propagating signal. However, labeling the tangible machine-readable medium 1522 as “non-transitory” should not be construed to mean that the medium is incapable of movement; the medium should be considered as being transportable from one physical location to another. Additionally, since the machine-readable medium 1522 is tangible, the medium may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium 1522 or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor 1502 or a group of processors 1502) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor 1502 or other programmable processor 1502. It will be appreciated that the decision to implement a hardware module mechanically, in dedicated and permanently configured circuitry, or in temporarily configured circuitry (e.g., configured by software) may be driven by cost and time considerations.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses 1508) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 1502 that are temporarily configured (e.g., by software) or permanently configured to perform the relevant operations. Whether temporarily or permanently configured, such processors 1502 may constitute processor-implemented modules that operate to perform one or more operations or functions described herein. As used herein, “processor-implemented module” refers to a hardware module implemented using one or more processors 1502.

Similarly, the methods described herein may be at least partially processor-implemented, a processor 1502 being an example of hardware. For example, at least some of the operations of a method may be performed by one or more processors 1502 or processor-implemented modules. As used herein, “processor-implemented module” refers to a hardware module in which the hardware includes one or more processors 1502. Moreover, the one or more processors 1502 may also operate to support performance of the relevant operations in a “cloud computing” environment or as a “software as a service” (SaaS). For example, at least some of the operations may be performed by a group of computers (as examples of machines 1500 including processors 1502), with these operations being accessible via a network 1526 (e.g., the Internet) and via one or more appropriate interfaces (e.g., an API).

The performance of certain operations may be distributed among the one or more processors 1502, not only residing within a single machine 1500, but deployed across a number of machines 1500. In some example embodiments, the one or more processors 1502 or processor-implemented modules may be located in a single geographic location (e.g., within a home environment, an office environment, or a server farm). In other example embodiments, the one or more processors 1502 or processor-implemented modules may be distributed across number of geographic locations.

Unless specifically stated otherwise, discussions herein using words such as “processing,” “computing,” “calculating,” “determining,” “presenting,” “displaying,” or the like may refer to actions or processes of a machine 900 (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The present disclosure is illustrative and not limiting. Further modifications will be apparent to one skilled in the art in light of this disclosure and are intended to fall within the scope of the appended claims.

What is claimed is:

1. A freight management system for improving transparency in shipping transactions, comprising:
at least one memory;
at least one receiver coupled to the at least one memory and configured to receive real-time sensor data from a plurality of shipping assets transporting products in a plurality of shipping transactions;
at least one processor coupled to the memory and configured to, in real time:
access the real-time sensor data;
cause display, in a graphical display of a shipper user, of status information about a shipping transaction among the plurality of shipping transactions, utilizing the real-time sensor data, wherein the shipper user has authorized a product being transported in the shipping transaction;
cause display, in a graphical display of a receiver user, of the status information about the shipping transaction, utilizing the real-time sensor data, wherein the receiver user is designated to receive the product being transported in the shipping transaction; and
cause display, in a graphical display of a carrier user associated with the shipping transaction, of the status information about the shipping transaction, utilizing the real-time sensor data, wherein the carrier user is in control of a shipping asset that is transporting the product in the shipping transaction.

2. The system of claim 1, wherein the status information comprises a plurality of load status identifiers signaling a current load status of the shipping transaction, the load status identifiers comprising: an “available” status, a “booked” status, a “dispatched” status, a “loading” status, a “loaded” status, an “unloading” status, an “empty” status, a “settled” status, a “partial” status, a “void” status, and an “outside” status.

3. The system of claim 1, wherein the status information comprises information about the carrier performing the shipping transaction, including: a carrier company name, a driver name, a driver contact information, an identifier of the shipping asset, at least one pick-up location, and at least one delivery location.

4. The system of claim 1, wherein causing display of the status information comprises displaying a shipping asset icon overlaid onto a geographic map at a present location of the shipping asset, according to location data derived from the real-time sensor data.

5. The system of claim 4, wherein the processor is further configured to:
access a cursor input placed over the shipping asset icon; and
in response, cause display of a floating window comprising additional real-time status information about the shipping transaction.

6. The system of claim 1, wherien the status information comprises information about the shipping asset transporting the product in the shipping transaction, including: current speed of the shipping asset, an indication of whether a shipping asset cargo door is closed, a trailer temperature setting indicating an intended temperature inside the trailer, and a current trailer temperature indicating an actual temperature inside the trailer.

7. The system of claim 1, wherein causing display of the status information comprises displaying a plurality of location icons associated with the shipping asset, the plurality of location icons positioned at different locations along a traveled route of the shipping asset during the shipping transaction, the plurality of location icons spaced at said different locations based on a regular time interval.

8. The system of claim 7, wherein the processor is further configured to:
access a cursor input placed over any of the location icons; and
in response, cause display of a floating window comprising status information about the shipping transaction during a time that the shipping asset traveled at said location icon.

9. The system of claim 1, wherein causing display of the status information comprises displaying a time series of status information over a period of time in a graphical plot.

10. The system of claim 9, wherein the time series of status information comprises a time series of shipping asset speed as a function of time.

11. The system of claim 9, wherein the time series of status information comprises a time series of shipping asset trailer temperature as a function of time.

12. The system of claim 9, wherein the time series of status information comprises a binary time series of when a trailer door is opened and closed as a function of time.

13. A freight management system for improving transparency in shipping transactions, comprising:
at least one memory;
at least one receiver coupled to the at least one memory and configured to receive real-time sensor data from a plurality of shipping assets transporting products in a plurality of shipping transactions;
at least one processor coupled to the memory and configured to, in real time:
access the real-time sensor data;
cause display, in a graphical display of a user, of status information about each shipping transaction among the plurality of shipping transactions, utilizing the real-time sensor data.

14. The system of claim 13, wherein causing display of the status information about each shipping transaction comprises displaying a shipping asset icon for each of a shipping asset associated with each shipping transaction, overlaid onto a geographic map at a present location of the shipping asset, according to location data derived from the real-time sensor data.

15. The system of claim 13, wherein the at least one processor is further configured to:
cause display of a number of the shipping assets conducting the plurality of shipping transactions;
cause display of a number of idle shipping assets not conducting any of the plurality of shipping transactions; and
cause display of a number of alarms raised associated with the plurality of shipping transactions.

16. The system of claim 13, wherein the at least one processor is further configured to:
provide filter functionality configured to filter out display of status information of one or more shipping transactions among the plurality of shipping transactions.

17. The system of claim 16, wherein the filter functionality includes filters based on: current locations of the shipping assets transporting the products in the plurality of shipping transactions; current load statuses of the shipping assets, shipping assets belonging to partnerships; shipping assets organized within a preselected group, and shipping assets controlled by a specified carrier company.

18. The system of claim 13, wherein causing display of the status information of each shipping transaction comprises displaying a plurality of location icons associated with each shipping asset associated with each shipping transaction, the plurality of location icons positioned at different locations along each traveled route of each shipping asset during their respective shipping transactions, the plurality of location icons spaced at said different locations based on a regular time interval.

19. A computer-readable medium having no transitory signals and embodying instructions that, when executed by a processor, perform operations comprising:
accessing real-time sensor data from a plurality of shipping assets transporting products in a plurality of shipping transaction;
causing display, in a graphical display of a shipper user, of status information about a shipping transaction among the plurality of shipping transactions, utilizing the real-time sensor data, wherein the shipper user has authorized a product being transported in the shipping transaction;
causing display, in a graphical display of a receiver user, of the status information about the shipping transaction, utilizing the real-time sensor data, wherein the receiver user is designated to receive the product being transported in the shipping transaction; and
causing display, in a graphical display of a carrier user associated with the shipping transaction, of the status information about the shipping transaction, utilizing the real-time sensor data, wherein the carrier user is in control of a shipping asset that is transporting the product in the shipping transaction.

20. The computer-readable medium of claim 19, wherein causing display of the status information comprises displaying a plurality of location icons associated with the shipping asset, the plurality of location icons positioned at different locations along a traveled route of the shipping asset during the shipping transaction, the plurality of location icons spaced at said different locations based on a regular time interval.
